(19) United States
(12) Patent Application Publication
(10) Pub. No.: US 2005/0288523 A1
(43) Pub. Date: Dec. 29, 2005

(54) Chiral diphosphorus compounds and transition metal complexes thereof

(76) Inventors: Paul Knochel, Gauting (DE); Tanasari Bunlaksananusorn, Leverkusen (DE); Andrei Gavryushin, Germering (DE)

Correspondence Address: LANXESS CORPORATION, 111 RIDC PARK WEST DRIVE, PITTSBURGH, PA, 15275-1112, US

(21) Appl. No.: 11/125,374

(22) Filed: May 9, 2005

(30) Foreign Application Priority Data
May 10, 2004 (DE) 1020040229007

(51) Int. Cl. C07F 9/02

(52) U.S. Cl. 556/13; 568/9

(57) ABSTRACT

The present invention relates to chiral diphosphorus compounds and transition metal complexes thereof, to a process for preparing chiral diphosphorus compounds and oxides thereof, and transition metal complexes comprising the chiral diphosphorus compounds. In a further aspect, the invention relates to the use of the chiral diphosphorus compounds or transition metal complexes thereof in asymmetric syntheses.

The present invention relates to chiral diphosphorus compounds and transition metal complexes thereof, and to a process for preparing chiral diphosphorus compounds and oxides thereof. In a further aspect, the invention relates to the use of the chiral diphosphorus compounds or transition metal complexes thereof in asymmetric syntheses.

Enantiomerically enriched chiral compounds are valuable starting substances for preparing agrochemicals and pharmaceuticals. Asymmetric catalysis has gained great industrial significance for the synthesis of such enantiomerically enriched chiral compounds.

The multitude of publications in the field of asymmetric synthesis shows clearly that transition metal complexes of diphosphorus compounds are particularly suitable as catalysts in asymmetric reactions (H. C. Brown, K. Murray, J. Am. Chem. Soc., 1959, 81, 4108). In particular, transition metal complexes of diphosphorus compounds have found use in industrial processes as catalysts in asymmetric hydrogenations of C═O, C═N and C═C bonds, hydrocyanations and hydroformylations.

For example, Achiwa et al., Synlett, 1991, 49 disclose that it is possible to use (1R,2R)-1-diphenylphosphino-2-diphenylphosphinomethylcyclopentane as a ligand in rhodium-catalysed hydrogenation to achieve satisfactory enantioselectivities.

However, the fundamental disadvantage is that the preparation process described does not allow steric and electronic variation of the ligand system which is needed for controlled optimization and adaptation of the ligand and thus of the catalyst for a given substrate. This disadvantage has hitherto complicated industrial utilization.

There is therefore a need to develop a ligand system which can be readily varied in its steric and electronic properties and whose transition metal complexes as catalysts in asymmetric synthesis, in particular asymmetric hydrogenations, enable not only high enantioselectivity but also high turnover rates. In addition, there is a need to develop convenient access for such a ligand system and the corresponding precursors.

Compounds of the formula (I) have now been found 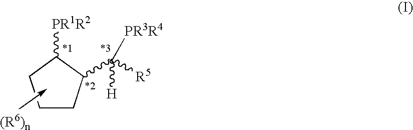
in which
*1, *2 and *3 each independently mark a stereogenic carbon atom which is in R- or S-configuration,
R¹, R², R³ and R⁴ may each independently be: alkyl, arylalkyl or aryl or a heterocyclic radical having a total of 4 to 16 carbon atoms, or R¹ and R² and/or R³ and R⁴ together may each be alkylene,
R⁵ may be: alkyl, arylalkyl or aryl and
R⁶ may be: alkyl, alkoxy, arylalkyl or aryl and
n may be: 0, 1 or 2.

The scope of the invention includes all radical definitions, parameters and illustrations listed above and hereinbelow, in general or within areas of preference, in any combination with one another, i.e. between the particular areas and areas of preference too.

In the context of the invention, unless stated specifically, aryl is preferably a carbocyclic aromatic radical having 6 to 24 skeleton carbon atoms or a heteroaromatic radical having 5 to 24 skeleton carbon atoms, in which no, one, two or three skeleton carbon atoms per cycle, but at least one skeleton carbon atom in the entire molecule, may be substituted by heteroatoms selected from the group of nitrogen, sulphur or oxygen. In addition, the carbocyclic aromatic radicals or heteroaromatic radicals may be substituted by up to five identical or different substituents per cycle, selected from the group of hydroxyl, fluorine, nitro, cyano, free or protected formyl, C₁-C₁₂-alkyl, C₅-C₁₄-aryl, C₆-C₁₅-arylalkyl, —PO—[(C₁-C₈)-alkyl]₂, —PO-[(C₅-C₁₄)-aryl]₂, —PO—[(C₁-C₈)-alkyl)(C₅-C₁₄)-aryl)], tri(C₁-C₈-alkyl)siloxy or radicals of the formulae (IIa) to (IIf). The same applies to the aryl moiety of an arylalkyl radical.

For example, aryl is more preferably phenyl, naphthyl or anthracenyl, each of which is optionally mono-, di- or trisubstituted by radicals which are each independently selected from the group of C₁-C₆-alkyl, C₅-C₁₄-aryl, C₁-C₆-alkoxy, C₁-C₆-alkoxy-carbonyl, halogen, hydroxyl, nitro or cyano.

In the context of the invention, alkyl, alkylene and alkoxy, unless stated specifically, are preferably each independently a straight-chain, cyclic, branched or unbranched alkyl, alkylene and alkoxy radical respectively, each of which may optionally be further substituted by C₁-C₄-alkoxy radicals. The same applies to the alkylene moiety of an arylalkyl radical.

For example, alkyl is more preferably methyl, ethyl, n-propyl, isopropyl, n-butyl, tert-butyl, n-pentyl, cyclohexyl and n-hexyl, n-heptyl, n-octyl, isooctyl, n-decyl and n-dodecyl.

For example, alkylene is preferably 1,3-propylene, 1,4-butylene, 1,5-pentylene, 1,6-hexylene, S,S- or R,R-2,5-hexylene, 1,4-cyclohexylene, 1,2-cyclohexylene and 1,8-octylene.

For example, alkoxy is preferably methoxy, ethoxy, isopropoxy, n-propoxy, n-butoxy, tert-butoxy and cyclohexyloxy.

In the context of the invention, arylalkyl, unless stated specifically, is preferably in each case independently a straight-chain, cyclic, branched or unbranched alkyl radical which is mono- or polysubstituted, more preferably monosubstituted, by aryl radicals as defined above.

In the context of the invention, unless stated specifically, haloalkyl and haloalkylene are preferably each independently a straight-chain, cyclic, branched or unbranched alkyl and alkylene radical respectively, each of which may be substituted singly, multiply or fully by halogen atoms selected independently from the group of fluorine, chlorine, bromine and iodine.

For example, haloalkyl is more preferably trifluoromethyl, trichloromethyl, 2,2,2-trifluoroethyl, pentafluoroethyl and nonafluorobutyl; C₁-C₈-fluoroalkyl is more preferably trifluoromethyl, 2,2,2-trifluoroethyl, pentafluoroethyl and nonafluorobutyl.

Preferred compounds of the formula (I) are defined below.
*1, *2 are preferably selected such that the corresponding phosphine substitutents, based on the level of the central five-membered ring, assume a cis-position. The compounds of the formula (I) are also preferably stereoisomerically enriched.
R¹ and R² or R³ and R⁴, preferably each in pairs and identically, are: alkyl or aryl or a heterocyclic radical having a total of 4 to 9 carbon atoms or, in each case together, are alkylene.
   More preferably, R¹ and R² or R³ and R⁴, in each case in pairs and identically, are: C₃-C₆-alkyl, optionally mono-, di- or tri-C₁-C₆-alkyl-, —C₁-C₆-haloalkyl-, —C₁-C₆-alkoxy-, -chlorine- or -fluorine-substituted phenyl, or, in each case together, are C₄-C₆-alkylene. Very particular preference is given to all four radicals R¹, R², R³ and R⁴ being identical.
R⁵ is preferably: C₁-C₆-alkyl
R⁵ may be: alkyl, arylalkyl or aryl and
n is preferably 0.

Very particularly preferred compounds of the formula (1) are: (1R, 2R)-1-diphenylphosphino-2-(1S-diphenylphosphinoethyl)cyclopentane, (1R, 2R)-1-diphenylphosphino-2-(1S-diphenylphosphino-2-methylpropyl)cyclopentane and (1R,2R)-1-diphenylphosphino-2-(S-diphenylphosphinocyclohexylmethyl)cyclopentane.

The invention also embraces complexes of compounds of the formula (I) with boranes, for example borane or borabicyclononane (BBN-9).

In the context of the invention, the terms stereoisomerically enriched and enantiomerically enriched include stereoisomerically pure and enantiomerically pure compounds and mixtures of stereoisomeric and enantiomeric compounds in which one stereoisomer or enantiomer is present in a greater relative proportion than the other stereoisomer(s) or enantiomer(s), preferably in a relative proportion of above 50 to 100 mol %, more preferably 90 to 100 mol % and even more preferably 98 to 100 mol %.

The compounds of the formula (I) can be prepared by a process which is likewise in accordance with the invention.

This process is characterized in that
in a step A), compounds of the formula (II) 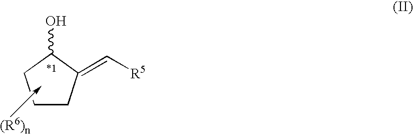
   in which *1 and R⁵ each have the definitions and areas of preference specified formula I and in which R⁵ may also be hydrogen
   are reacted with compounds of the formula (III)
   Hal-PR³R⁴ (III)
   to give compounds of the formula (IV) 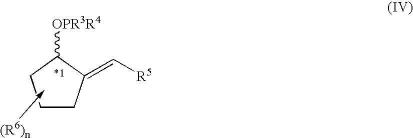
   and
in a step B), the compounds of the formula (IV), optionally in an organic solvent, are converted by heating to at least 60° C. to compounds of the formula (V) 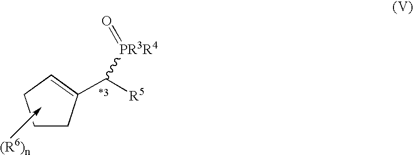
and, in a step C), the compounds of the formula (V) are converted by reacting with a borane and subsequently oxidizing to compounds of the formula (VI) 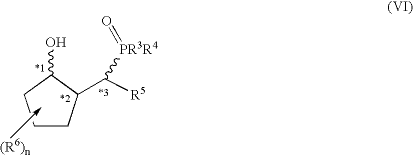
and, in a step D), the compounds of the formula (VI) are converted by reduction to compounds of the formula (VII) 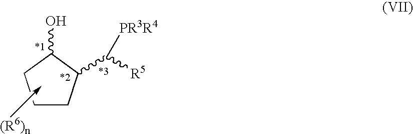
and, in a step E), the compounds of the formula (VII) are converted by reacting with compounds of the formula (VIII)
   Hal-O₂SR⁷ (VIII)
   to compounds of the formula (IX) 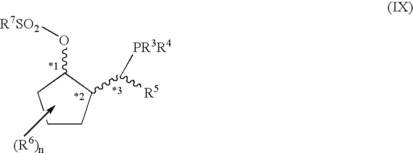
and, in a step F), the compounds of the formula (IX) are converted by reacting with compounds of the formula (X)
   HPR¹R² (X)
   to the compounds of the formula (I)

In the formulae (II), (IV), (V), (VI), (VII), (IX) and (X) *1, *2 and *3, R¹, R², R³, R⁴, R⁵ and R⁶ each have the same definitions and areas of preference as have already been described under the formula (I).

Moreover, R⁷ in the formulae (VIII) and (IX) is alkyl, fluoroalkyl, arylalkyl or aryl, preferably alkyl and fluoroalkyl.

In the formulae (III) and (VIII), Hal is in each case chlorine, bromine or iodine, preferably chlorine.

The compounds of the formulae (II), (IV), (V), (VI), (VII) and (IX) are hitherto unknown and therefore likewise embraced by the invention as indispensable intermediates. The definitions and areas of preference specified above for *1, *2 and *3, R¹, R², R³, R⁴, R⁵, R⁶ and R⁷ each apply in the same manner.

Also embraced by the invention are complexes of compounds of the formula (VII) with boranes, for example borane or borabicyclononane (BBN-9).

The invention further provides processes which comprise the steps below, as have been described above:
F) or A)
E) and F) or A) and B)
D), E) and F) or A), B) and C)
C), D), E) and F) or A), B) C) and D)
B), C), D), E) and F) or A), B), C), D) and E)

The chemical nature of the individual steps is already known in principle and they can be employed in a similar manner to the inventive compounds.

Preferred compounds of the formula (II) are:
(1S)-2-ethylidenecyclopentanol, (1S)-2-(2-methylpropylidene)cyclopentanol and (1S)-2-cyclohexylmethylidenecyclopentanol.

A preferred compound of the formula (III) is chlorodiphenylphosphine.

Preferred compounds of the formula (IV) are:
(1R)-diphenylphosphinoxy-2-ethylidenecyclopentane, (1R)-diphenylphosphinoxy-2-(2-methylpropylidene)cyclopentane and (1R)-diphenylphosphinoxy-2-cyclo-hexylmethylidenecyclopentane.

Preferred compounds of the formula (V) are:
(1S)-diphenylphosphinoylethylcyclopentene, ((1S)-diphenylphosphinoyl-2-methylpropyl)cyclopentene and ((1S)-diphenylphosphinoyl-1-methylcyclohexyl)cyclopentene.

Preferred compounds of the formula (VI) are:
(1S, 2R)-1-hydroxy-2-(1S-diphenylphosphinoylethyl)cyclopentane, (1S, 2R)-1hydroxy-2-(1S-diphenylphosphinoyl-2-methylpropyl)cyclopentane and (1S,2R)-1-hydroxy-2-(S-diphenylphosphinoylcyclohexylmethyl)cyclopentane.

Preferred compounds of the formula (VI) are:
(1S,2R)-1-hydroxy-2-(1S-diphenylphosphinoethyl)cyclopentane, (1S,2R)-1-hydroxy-2-(1S-diphenylphosphino-2-methylpropyl)cyclopentane and (1S,2R)-1-hydroxy-2-(S-diphenylphosphinocyclohexylmethyl)cyclopentane.

Preferred compounds of the formula (IX) are:
(1S,2R)-1-methanesulphonyloxy-2-(1S-diphenylphosphinoethyl)cyclopentane, (15,2R)-1-methanesulphonyloxy-2-(1S-diphenylphosphino-2-methylpropyl)cyclopentane and (1S,2R)-1-methanesulphonyloxy-2-(S-diphenylphosphinocyclohexylmethyl)cyclopentane.

A preferred compound of the formula (X) is diphenylphosphine.

In the manner described, the compounds of the formula (I) are obtainable in high yields in an efficient manner.

The invention also embraces transition metal complexes which comprise the inventive compounds of the formula (I).

Transition metal complexes are preferably those of ruthenium, osmium, cobalt, rhodium, iridium, nickel, palladium, platinum and copper, preferably those of ruthenium, rhodium, iridium, nickel, palladium and platinum, more preferably those of ruthenium, rhodium, iridium and palladium.

The inventive transition metal complexes are especially suitable as catalysts. The invention therefore also embraces catalysts which comprise the inventive transition metal complexes.

The catalysts used may, for example, either be isolated transition metal complexes or be those transition metal complexes which are obtainable by reacting transition metal compounds and compounds of the formula (I).

Isolated transition metal complexes which contain the compounds of the formula (I) are preferably those in which the ratio of transition metal to compound of the formula (I) is 1:1.

Preference is given to the inventive compounds of the formula (XI)
[(I)L¹₂M][An¹] (XI)
in which (I) represents compounds of the formula (I) with the definition specified there and its areas of preference and
M is rhodium or iridium and
L¹ is in each case a C₂-C₁₂-alkene, for example ethylene or cyclooctene, or a nitrile, for example acetonitrile, benzonitrile or benzyl nitrile, or
L¹₂ together is a (C₄-C₁₂) diene, for example bicyclo[2.1.1]hepta-2,5-diene (norbornadiene) or 1,5-cyclooctadiene and
[An¹] is an anion, preferably methanesulphonate, trifluoromethanesulphonate, tetra-fluoroborate, hexafluorophosphate, perchlorate, hexafluoroantimonate, tetra(bis-3,5-trifluoromethylphenyl)borate or tetraphenylborate.

Preferred transition metal complexes are those which are obtainable by reacting transition metal compounds and compounds of the formula (I)

Suitable transition metal compounds are, for example, those of the formula
M(An²)_{q} (XIIa)
in which
M is rhodium, iridium, ruthenium, nickel, palladium, platinum or copper and
An² is chloride, bromide, acetate, nitrate, methanesulphonate, trifluoromethanesulphonate or acetylacetonate and
q is 3 for rhodium, iridium and ruthenium, is 2 for nickel, palladium and platinum, and is 1 for copper,
or transition metal compounds of the formula (XIIb)
   M(An³)_{q}L¹₂ (XIIb)
   in which
M is ruthenium, iridium, ruthenium, nickel, palladium, platinum or copper and
An³ is chloride, bromide, acetate, acetylacetonate, methanesulphonate or trifluoromethanesulphonate, tetrafluoroborate or hexafluorophosphate, perchlorate, hexafluoroantimonate, tetra(bis-3,5-trifluoromethylphenyl)borate or tetraphenylborate and
q is 1 for rhodium and iridium, is 2 for ruthenium, nickel, palladium and platinum, and is 1 for copper,
L¹ is in each case a C₂-C₁₂-alkene, for example ethylene or cyclooctene, or a nitrile, for example acetonitrile, benzonitrile or benzyl nitrile, or
L¹₂ together is a (C₄-C₁₂) diene, for example bicyclo[2.1.1]hepta-2,5-diene (norbornadiene) or 1,5-cyclooctadiene or transition metal compounds of the formula (XIIc)
   [ML²An¹₂]₂ (XIIc)
   in which
M is ruthenium and
L² is an aryl radical, for example cymene, mesityl, phenyl or cyclooctadiene, norbornadiene or methylallyl,
   or transition metal compounds of the formula (XIId)
   Met³_{q}[M(An⁴)₄] (XIId)
   in which
M is palladium, nickel, iridium or rhodium and
An⁴ is chloride or bromide and
Met is lithium, sodium, potassium, ammonium or organic ammonium and
q is 3 for rhodium and iridium, 2 for nickel, palladium and platinum, or transition metal compounds of the formula (XIIe)
   [M(L³)₂]An⁵ (XIIe)
   in which
M is iridium or rhodium and
L³ is (C₄-C₁₂) diene, for example bicyclo[2.1.1]hepta-2,5-diene (norbornadiene) or 1,5-cyclooctadiene and
An⁵ is a noncoordinating or weakly coordinating anion, for example methanesulphonate, trifluoromethanesulphonate, tetrafluoroborate, hexafluorophosphate, perchlorate, hexafluoroantimonate, tetra(bis-3,5-trifluoromethylphenyl)borate or tetraphenylborate.

Additionally suitable as transition metal compounds are, for example, Ni(1,5-cyclooctadiene)₂, Pd₂(dibenzylideneacetone)₃, Pd[PPh₃]₄, cyclopentadienyl₂Ru, Rh(acac)(CO)₂, Ir(pyridine)₂(1,5-cyclooctadiene), Cu(phenyl)Br, Cu(phenyl)Cl, Cu(phenyl)I, Cu(PPh₃)₂Br, [Cu(CH₃CN)₄]BF₄ and [Cu(CH₃CN)₄]PF₆ or polynuclear bridged complexes, for example [Rh(1,5-cyclooctadiene)Cl]₂, [Rh(1,5-cyclooctadiene)Br]₂, [Rh(ethene)₂Cl]₂, [Rh(cyclooctene)₂Cl]₂.

The transition metal compounds used are preferably:

[Rh(cod)(acac)] where acac is acetylacetonate, [Ir(ethylene)₂(acac)], [Rh(ethylene)₂(acac)], [Rh(cod)Cl]₂, [Rh(cod)Br]₂, [Rh(cod)₂]ClO₄, [Rh(cod)₂]BF₄, [Rh(cod)₂]PF₄, [Rh(cod)₂]ClO₆, [Rh(cod)₂]OTf, [Rh(cod)₂]BAr₄ (Ar=3,5-bistrifluoromethylphenyl), [Rh(cod)₂]SbF₆, RuCl₂(cod), [(cymene)RuCl₂]₂, [(benzene)RuCl₂]₂, [(mesityl)RuCl₂]₂, [(cymene)RuBr₂]₂, [(cymene)Rul₂]₂, [(cymene)Ru(BF₄)₂]₂, [(cymene)Ru(PF₆)₂]₂, [(cymene)Ru(BAr₄)₂]₂ (Ar=3,5-bistrifluoromethylphenyl), [(cymene)Ru(SbF₆)₂]₂, [Ir(cod)Cl]₂, [Ir(cod)₂]PF₆, [Ir(cod)₂]ClO₄, [Ir(cod)₂]SbF₆, [Ir(cod)₂]BF₄, [Ir(cod)₂]OTf, [Ir(cod)₂]BAr₄ (Ar=3,5-bistrifluoromethylphenyl), RuCl₃, NiCl₃, RhCl₃, PdCl₂, PdBr₂, Pd(OAc)₂, Pd₂(dibenzylideneacetone)₃, Pd(acetylacetonate)₂, CuOTf, CuI, CuCl, Cu(OTf)₂, CuBr, CuI, CuBr₂, CuCl₂, CuI₂, [Rh(nbd)Cl]₂, [Rh(nbd)Br]₂, [Rh(nbd)₂]ClO₄, [Rh(nbd)₂]BF₄, [Rh(nbd)₂]PF₆, [Rh(nbd)₂]OTf, [Rh(nbd)₂]BAr₄ (Ar=3,5-bistrifluoromethylphenyl), [Rh(nbd)₂]SbF₆, RuCl₂(nbd), [Ir(nbd)₂]PF₆, [Ir(nbd)₂]ClO₄, [Ir(nbd)₂]SbF₆, [Ir(nbd)₂]BF₄, [Ir(nbd)₂]OTf, [Ir(nbd)₂]BAr₄ (Ar=3,5-bistrifluoromethylphenyl), Ir(pyridine)₂(nbd), [Ru(DMSO)₄Cl₂], [Ru(CH₃CN)₄Cl₂], [Ru(PhCN)₄Cl₂], [Ru(cod)Cl₂]ₙ, [Ru(cod)₄(methallyl)₂], [Ru(acetylacetonate)₃].

The amount of the transition metal compounds used may, for example, be 25 to 200 mol % based on the compound of the formula (D used; preference is given to 50 to 150 mol %, very particular preference to 75 to 125 mol % and even greater preference to 100 to 125 mol %.

The catalysts which comprise the inventive transition metal complexes are especially suitable for use in a process for preparing stereoisomerically enriched, preferably enantiomerically enriched, compounds.

Preference is given to using the catalysts for asymmetric 1,4-additions, asymmetric hydroformylations, asymmetric allylic substitutions, asymmetric hydrocyanations, asymmetric Heck reactions, asymmetric hydroborations and asymmetric hydrogenations, more preferably for asymmetric hydrogenations, asymmetric 1,4-additions, asymmetric hydroborations and asymmetric allylic substitutions.

Preferred asymmetric hydrogenations are, for example, hydrogenations of prochirals C═C bonds, for example of prochiral enamines, enamides, olefins, enol ethers, C═O bonds, for example of prochiral ketones, and C═N bonds, for example of prochiral imines. Particularly preferred asymmetric hydrogenations are hydrogenations of prochiral C═C bonds, for example of prochiral enamines and enamides, olefins.

The invention therefore also embraces a process for preparing stereoisomerically enriched, preferably enantiomerically enriched, compounds by catalytic hydrogenating olefins, enamines, enamides, imines or ketones, which is characterized in that the catalysts used are those which comprise transition metal complexes of compounds of the formula (I) with the definitions specified there.

The amount of the transition metal compound used or of the transition metal complex used may, for example, be 0.001 to 5 mol %, based on the substrate used; preference is given to from 0.001 to 0.5 mol %, very particular preference to 0.001 to 0.1 mol % and even greater preference to 0.001 to 0.008 mol %.

In a preferred embodiment, asymmetric hydrogenations, 1,4-additions and hydroborations may be carried out, for example, in such a way that the catalyst is obtained from a transition metal compound and compound of the formula (1), optionally in a suitable solvent, the substrate is added and the reaction mixture is admixed with the reactant at reaction temperature (hydrogen, boronic acids, boranes, etc.).

Suitable solvents for the asymmetric catalysis are, for example, chlorinated alkanes such as methyl chloride, short-chain C₁-C₆-alcohols, e.g. methanol, isopropanol or ethanol, aromatic hydrocarbons, e.g. toluene or benzene, ketones, e.g. acetone, or carboxylic esters, e.g. ethyl acetate.

The asymmetric catalysis is carried out advantageously at a temperature of −20° C. to 200° C., preferably 0 to 1001C and more preferably at 20° to 70° C.

The inventive catalysts are especially suitable in a process for preparing stereoisomerically enriched, preferably enantiomerically enriched, active ingredients in medicaments and agrochemicals, or intermediates of these two classes.

The advantage of the present invention is that the compounds of the formula (I) can be prepared in an efficient manner, and their electronic and steric properties are variable to a wide degree starting from readily available reactants. In addition, the inventive ligands and their transition metal complexes show good performance in asymmetric syntheses.

### EXAMPLES

General Procedure 1 for the Synthesis of 2-alkylidenecyclopentanones

A 2 l Erlenmeyer flask was charged with 1 l of H₂O, 15 g of KOH, 100 ml of MTBE and 30 ml of cyclopentanone. A solution of 0.3 mol of the particular aldehyde in 50 ml of MTBE was introduced dropwise at room temperature into the vigorously stirred mixture within 2 h. The reaction mixture was stirred for a further 30 min and then neutralized with conc. HCl. The organic phase was removed and the solvent was removed under reduced pressure. The residue was distilled fractionally with a 40 cm Vigreux column under reduced pressure. The typical yield range is 18 to 45%.

General Procedure 2 for the reduction of 2-alkylidenecyclopentanones to the corresponding alcohols

In a 500 ml round-bottomed flask, 36 g of CeCl₃.7H₂O were dissolved in 210 ml of methanol. 150 mM of the ketone were added, the mixture was cooled to 0° C. and 4.0 g of solid NaBH₄ were subsequently added in small portions in such a way that the temperature did not rise above 5° C. The reaction mixture was stirred for a further 15 min and then added to 250 g of ice. The reaction mixture was allowed to warm to room temperature with stirring, the upper phase was removed and the aqueous phase was extracted three times with 100 ml each time of diethyl ether. The combined organic phases were washed with 50 ml of H₂O and 50 ml of saturated sodium chloride solution, and dried over magnesium sulphate, and the solvent was removed under reduced pressure. The residue was fractionally distilled with a 40 cm Vigreux column under reduced pressure. Typical yield range: 93 to 96%.

General Procedure 3 for the Enzymatic Kinetic Optical Resolution of 2-alkylidene-cyclopentanols

100 mM of the particular alcohol were dissolved in 200 ml of hexane, then 20 ml of vinyl acetate and 0.80 g of Amano PS lipase (Pseudomonas cepacia, Aldrich) were added. The reaction mixture was stirred at 44 to 45° C. (internal temperature) for 6 to 8 h (GC monitoring), and then filtered through celite, and the solvent was removed under reduced pressure. The products were separated by means of chromatography (silica gel, 3:1 pentane-ether). The enantiomeric excess was determined on a chiral GC column (TFA-cyclodextrin column). The ee value was typically 99%, both for the alcohols and for the acetates. Typical yield range: 47 to 48%.

General Procedure 4 for the Allyl Phosphinite-Allylphosphine Oxide Rearrangement

12 mM of the chiral allyl alcohol were dissolved in 50 ml of anhydrous toluene under an argon atmosphere. 1.50 g of 4-dimethylaminopyridine (Acros) were added. The mixture was cooled to −30° C. and 2.2 ml of freshly distilled Ph₂PCl (Strem) were added slowly at this temperature. The mixture was allowed to warm to room temperature and then heated to 80° C. for 6 h (monitoring with ³¹P NMR). The reaction mixture was cooled to room temperature and filtered through a 2 cm silica gel layer, and the filtercake was washed repeatedly with toluene. The solvent of the filtrate was removed under reduced pressure. The residue was recrystallized from heptane/CH₂Cl₂. Typical yield range: 70 to 77%.

General Procedure 5 for the Synthesis of Diphenylphosphinoyl Alcohols from Allylphosphine Oxides.

4 mM of the allylphosphine oxide were introduced under an argon atmosphere into a 20 ml glass autoclave (Ace®, Aldrich) and dissolved in 12 ml of a 0.5 M solution of 9-BBN in THF (Aldrich). The solution was heated to 75° C. for 48 h and then cooled to room temperature.

In a 250 ml flask, 6.0 g of m-chloroperbenzoic acid (70-75%, Acros) were dissolved in 40 ml of CH₂Cl₂. The solution was dried over MgSO₄ for 5 min and then filtered. The flask was immersed in an acetone/dry ice bath and the solution of the borane adduct (see above) was added dropwise in such a way that the internal temperature was 10 to 15° C. After the end of the addition, the reaction mixture was stirred for a further 30 min and washed twice with 50 ml each time of 20% eq. Na₂S₂O₅, and twice with 30 ml each time of 2 N NaOH and saturated sodium chloride solution. The filtrate was dried over magnesium sulphate and the solvent was removed under reduced pressure. 25 ml of diethyl ether were added to the residue and the mixture was stirred at room temperature for 12 h. The white precipitate was filtered off, washed with diethyl ether and dried under reduced pressure. Typical yield range: 55 to 67%.

General Procedure 6 for the Conversion of Diphenylphosphine Oxides to Diphenylphosphine-Borane Complexes

Under an argon atmosphere, a dry Schlenk vessel was charged with 5 mM of the particular phosphine oxide, 20 ml of anhydrous toluene, 2 ml of polymethylhydrosiloxane (Aldrich) and 1.5 ml of titanium isopropoxide (Acros). A sample of the reaction mixture was transferred into an NMR tube in order to monitor the reaction. The reaction mixture and the NMR tube were heated to 105° C. for 2 to 4 h until full reduction was observed in the ³¹p NMR (oxide signals at 30 to 40 ppm, phosphines −20 to 0 ppm). The reaction mixture was cooled to room temperature and 1 ml of borane-dimethyl sulphide complex (Aldrich) was added. After 5 minutes, the reaction mixture was introduced cautiously into a 250 ml Erlenmeyer flask with 5 ml of methanol (H₂ evolution!). After the gas evolution had abated, the solution was transferred into a 250 ml Nalgene®) bottle with 20 ml of 48% HF and 20 ml of H₂O, and then stirred at room temperature for 12 h. The organic phase was removed and the aqueous phase was extracted with 15 ml of toluene. The combined organic phases were washed with saturated NaHCO₃ solution and saturated sodium chloride solution, and dried over magnesium sulphate, and the solvent was removed under reduced pressure. The residue was taken up in 5 ml of diethyl ether and filtered through a 3 cm silica gel layer. The filter residue was washed with 5 ml of diethyl ether and the solvent of the filtrate was removed under reduced pressure. The residue was dried under high vacuum and the phosphine-borane complex was obtained as a viscous oil which solidified in the course of standing. Typical yield range: 94 to 96%.

General Procedure 7 for the Conversion of Phosphine-Borane Alcohols to the Corresponding Mesylates and the Substitution Thereof with Diphenylphosphine.

Under an argon atmosphere, a 100 ml dry Schlenk vessel was charged with 5 mM of a phosphine-borane alcohol and 40 ml of dry dichloromethane. The mixture was cooled to −30° C. and 2.4 ml of anhydrous triethylamine were added.

1.2 ml of methanesulphonyl chloride were then added dropwise at this temperature with vigorous stirring. The reaction mixture was left at −30° C. for 2 h and was introduced at this temperature with stirring into 200 ml of anhydrous diethyl ether. After 5 min, the white precipitate was filtered off through a 3 cm silica gel layer. The filtercake was washed with 100 ml of diethyl ether and the solvent was removed under reduced pressure down to a residue of 10 ml. The remaining solvent was removed under high vacuum in order to prevent thermal stress. The remaining residue was left under high vacuum for 5 h in order to remove traces of MsCl. The thus obtained mesylate was used in the next step without further purification.

In a 100 ml Schlenk vessel under an argon atmosphere, 2.00 g of t-BuOK in 25 ml of anhydrous THF and 2.32 g (3 equivalents) of diphenylphosphine (Strem) were combined. The orange-coloured solution was cooled to −20° C. and the above-described mesylate in 10 ml of THF was added slowly. The reaction mixture was allowed to warm to room temperature and then heated to 50° C. for 18 h. After cooling to room temperature, 2.5 ml of borane-dimethyl sulphide complex (Aldrich) were added. The contents of the reaction vessel were introduced cautiously into a 250 ml Erlenmeyer flask with 10 ml of methanol. After the gas evolution had abated, 50 ml of saturated NH₄Cl solution were added, the organic phase was removed and the aqueous phase was extracted twice with 20 ml each time of dichloromethane. The combined organic phases were washed with saturated sodium chloride solution and dried over magnesium sulphate, and the solvent was removed under reduced pressure. The residue was dissolved in 5 ml of dichloromethane-pentane (1:1) and filtered through a 5 cm aluminium oxide layer on a 25 mm (diameter) filter. The majority of the solvent was removed under reduced pressure and the residue was diluted with 15 ml of diethyl ether and left at 0° C. for 12 h. The solid formed was filtered off and dried under reduced pressure. Typical yield range 52 to 54%.

General Procedure 8 for the Deprotection of a Phosphine-Borane with N,N′-bis(3-aminopropyl)piperazine

Phosphine-borane (1 mM) was introduced under an argon atmosphere into a 10 ml Schlenk vessel and dissolved in 2 ml of anhydrous toluene. 1 ml of N,N′-bis-(3-aminopropyl)piperazine (Lancaster) was added to this solution. The reaction mixture was heated to 105° C. for 2 h, cooled to room temperature and diluted with 10 ml of diethyl ether. Under an argon atmosphere, the mixture was filtered through diethyl ether-moistened silica gel into a flask (very strict oxygen exclusion). The silica gel was rewashed twice with 30 ml each time of diethyl ether. The solvent was removed under reduced pressure. The resulting phosphine is obtained as a white foam or highly viscous oil which solidifies. The product was stored under an argon atmosphere. Typical yield range: 99 to 100%.

### Example 1

### Synthesis of {(1S)-1(R)-[2(R)-diphenylphosphino)cyclopentyl]ethyl}(diphenyl)-phosphine

1a) (2E)-2-Ethylidenecyclopentanone

Synthesized according to General Procedure 1 using acetaldehyde. Yield 18%, b.p. 60-65° C. (10 mbar)
1b) (1R,2E)-2-Ethylidenecyclopentanol

Synthesized from 1a according to General Procedures 2 and 3. Yields: 93% and 47% (44% overall), b.p. 82-83° C. (10 mbar).
1c) (S)-(1-Cyclopent-1-en-1-ylethyl)(diphenyl)phosphine oxide

Synthesized from 1b) according to General Procedure 4. Yield 70%.
1d) (1S,2S)-2-[(1S)-1-(Diphenylphosphoryl)ethyl]cyclopentanol

Synthesized from 1c) according to General Procedure 5. Yield 67%.
1e) (1S,2S)-2-[(1S)-1-(Diphenylphosphino)ethyl]cyclopentanol-borane complex

Synthesized from 1d) according to General Procedure 6. Yield 94%.
1f) {(1S)-1(R)-[(2R)-2-(Diphenylphosphino)cyclopentyl]ethyl} (diphenyl)phosphine bis-borane complex

Synthesized from 1e) according to General Procedure 7. Yield 54%.

1 g) {(1S)-1(R)-[(2R)-2-(Diphenylphosphino)cyclopentyl] ethyl} (diphenyl)phosphine

Synthesized from 1f) according to General Procedure 8. Yield 97%.

### Example 2

### Synthesis of {(1S)-1(S)-[(2R)-2-diphenylphosphino)cyclopentyl]-2-methylpropyl}(diphenyl)phosphine

2a) (2E)-2-Isobutylidenecyclopentanone

Synthesized according to General Procedure 1 using isobutyraldehyde. Yield 45%, b.p. 88-90° C. (10 mbar)
2b) (1R,2E)-2-Isobutylidenecyclopentanol

Synthesized from 2a) according to General Procedures 2 and 3. Yields 95% and 48% (46% overall), b.p. 95-98° C. (10 mbar).
2c) (S)-(1-Cyclopent-1-en-1-yl)-2-methylpropyl)(diphenyl)phosphine oxide Synthesized from 2b) according to General Procedure 4. Yield 77%.
2d) (1S,2S)-2-[(1S)-1-(Diphenylphosphoryl)-2-methylpropyl]cyclopentanol

Synthesized from 2c) according to General Procedure 5. Yield 65%.
2e) (1S,2S)-2-[(1S)-1-(Diphenylphosphino)-2-methylpropyl]cyclopentanol-borane complex

Synthesized from 2d) according to General Procedure 6. Yield 96%.
2f) {(1S)-1(S)-[(2R)-2-(Diphenylphosphino)cyclopentyl]-2-methylpropyl} (diphenyl)-phosphine-bisborane complex

Synthesized from 2e) according to General Procedure 7. Yield 52%.
2g) {(1S)-1(S)-[(2R)-2-(Diphenylphosphino)cyclopentyl]2-methylpropyl}(diphenyl)-phosphine

Synthesized from 2f) according to General Procedure 8. Yield 98%.

### Example 3

### Synthesis of {(S)-cyclohexyl[(1S,2R)-2-(diphenylphosphino)cyclopentyl]methyl}(diphenyl)phosphine

3a) (2E)-2-Cyclohexylmethylenecyclopentanone

Synthesized according to General Procedure 1 using cyclohexane carbaldehyde. Yield 36%, b.p. 91-95° C. (0.5 mbar).
3b) (1R,2E)-2-Cyclohexylmethylenecyclopentanol

Synthesized from 3a) according to General Procedures 2 and 3. Yields 96% and 48% (46% overall), b.p. 100-103° C. (10 mbar).
3c) [(S)-Cyclohexyl(cyclopent-1-en-1-yl)methyl](diphenyl)phosphine oxide

Synthesized from 3b) according to General Procedure 4. Yield 76%.
3d) (1S,2S)-2-[(S)-Cyclohexyl(diphenylphosphoryl)methyl]cyclopentanol

Synthesized from 3c) according to General Procedure 5. Yield 55%.
3e) (1S,2S)-2-[(S)-Cyclohexyl(diphenylphosphino)methyl]cyclopentanol-borane complex

Synthesized from 3d) according to General Procedure 6. Yield 96%.
3f) {(S)-Cyclohexyl[(1S,2R)-2-(diphenylphosphino)cyclopentyl]methyl}(diphenyl)-phosphine-bisborane complex

Synthesized from 3e) according to General Procedure 7. Yield 52%.
3g) {(S)-Cyclohexyl[(1S,2R)-2-(diphenylphosphino)cyclopentyl]methyl}(diphenyl)-phosphine

Synthesized from 3′) according to General Procedure 8. Yield 94%.

For the examples below, the ligands of the formula (I) are used and are abbreviated as follows:

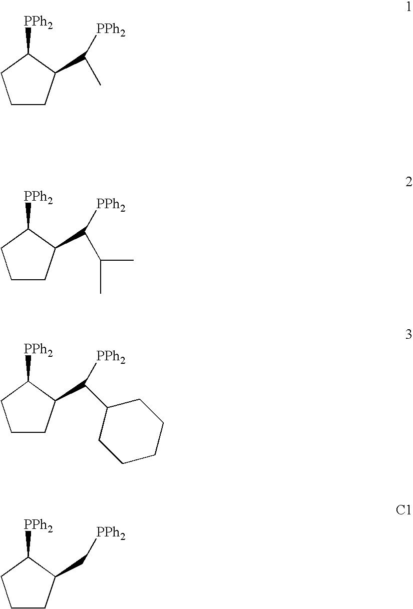

### Examples 4 to 13

Rhodium-catalysed asymmetric 1,4-addition of phenylboronic acids to 2-cyclohexenone

General procedure for the Rh-catalysed asymmetric 1,4-addition of phenylboronic acid to 2-cyclohexenone

Under an argon atmosphere, Rh(acac)(cod) (3.7 mg, 12 μmol), the chiral diphosphine (12 μmol), PhB(OH)₂ (244 mg, 2 mmol), anhydrous dioxane (2 ml) and 2-cyclohexenone (0.04 ml, 0.4 mmol) were introduced into a Schlenk vessel. The mixture was stirred at room temperature for 15 min and H₂O (0.1 ml) was added. The reaction mixture was stirred at 100° C. for 3 h. Water (5 ml) was added and the mixture was extracted twice with 5 ml each time of diethyl ether. The combined organic phases were washed with 5 ml of saturated sodium chloride solution and dried over magnesium sulphate, and the solvent was removed under reduced pressure. Purification by flash chromatography (25% Et₂O in pentane) gave (R)-3-phenylcyclohexanone (68.2 mg, 98%) with 88% ee as a colourless oil.

HPLC (Chiralcel OD-H, n-heptane/1-PrOH 99/2, 0.3 ml/min, 215 nm): tᵣ/min=44.0 (S), 47.0 (R).

¹H NMR (300 MHz, CDCl₃): δ 7.30-7.20 (m, 5H), 3.01 (m, 1H), 2.60-2.30 (m, 4H), 2.10-2.00 (m, 2H), 1.89-1.70 (m, 2H) ppm.

¹³C NMR (75 MHz, CDCl₃): δ 211.0, 144.3, 128.6, 126.6, 126.5, 48.9, 44.7, 41.1, 32.7, 25.5 ppm.

TABLE 1
1,4-addition of phenylboronic acid to cyclohexenone

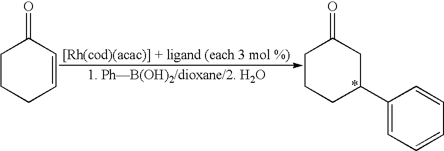

| Example | Ligand | T[° C.], t[h] | % ee | % Conversion | % Yield |
|---|---|---|---|---|---|
| 4 | C1 | 100, 2.5 | 31 (R) | 100 | 83 |
| 5 | 1 | 100, 2.5 | 88 (R) | 100 | 86 |
| 6 | 2 | 100, 16 | 45 (R) | 100 | 88 |
| 7 | 2 | 100, 2.5 | 57 (R) | 100 | 87 |
| 8 | 3 | 100, 2.5 | 68 (R) | 100 | 88 |

TABLE 2
1,4-addition of phenylboronic acid to cyclohexenone as a function of
temperature, reaction time and rhodium compound used (ligand 1,
otherwise the same conditions as specified for Table 1)

| | | T [° C.], | | | % |
|---|---|---|---|---|---|
| Example | [Rh] | t [h] | % ee | % Conversion | Yield |
| 9 | Rh(cod)acac | 100, 2.5 | 88 (R) | 100 | 86 |
| 10 | Rh(C₂H₄)₂acac | 100, 2.5 | 63 (R) | 100 | 88 |
| 11 | Rh(C₂H₄)₂acac | 70, 5 | 35 (R) | 100 | 88 |
| 12 | Rh(cod)acac | 70, 5 | 10 (R) | 100 | 92 |
| 13 | Rh(cod)acac | 110, 1 | 36 (R) | 100 | 99 |

### Examples 14 to 16

Rhodium-catalysed asymmetric hydroboration of styrene

General procedure for the Rh-catalysed hydroboration of styrene with catecholborane

A mixture of [Rh(cod₂)]BF₄ (8.1 mg, 0.020 mmol, 1 mol %) and the chiral diphosphine (0.020=mol, 1 mol % in Et₂O) in dry THF (2 ml) was stirred at room temperature for 10 min in a 10 ml Schlenk vessel under an argon atmosphere. Styrene (2 mmol, 0.23 ml) was added to the orange-coloured solution. The homogeneous reaction mixture was cooled to −20° C. and stirred at this temperature for 15 min before freshly distilled catecholborane (2.4 mmol, 0.26 ml) was added. The reaction mixture was stirred at −10° C. for 16 h and then quenched by adding EtOH (2 ml). Aqueous NaOH (2 M, 2 ml) and 30% H₂O₂ were added successively and the reaction mixture was warmed to room temperature with vigorous stirring over 2 h. The mixture was then extracted twice with 5 ml each time of Et₂O. The combined organic phases were washed with in each case 2 ml of NaOH (1 M) and saturated sodium chloride solution, and dried over magnesium sulphate. The residue was purified by means of flash chromatography (20% Et₂O in pentane). In this way, (R)-phenylethanol (72%, 176 mg) was obtained as a colourless liquid with 80% ee.

HPLC (Chiralcel OD-H, n-heptane/i-PrOH 98/2, 0.4 ml/min, 215 nm): trimin=35.5 (R), 43.7 (S).

¹H NMR (300 MHz, CDCl₃): δ 7.20-7.09 (m, 5H), 4.66 (q, J=6.5 Hz, 1H), 2.80 (br 1.30 (d, J=6.5 Hz, 3H) ppm.

¹³C NMR (75 MHz, CDCl₃): δ 146.4, 128.8, 127.7, 125.9, 70.6, 25.6 ppm.

TABLE 3
Hydroboration of styrene with catecholborane

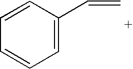

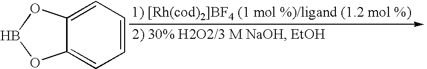

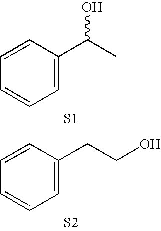

| | Li- | T [° C.], | Sol- | | | Con- | |
|---|---|---|---|---|---|---|---|
| Example | gand | t [h] | vent | T1:T2 | % ee^{a} | version | Yield |
| 14 | 1 | −20, 16 | THF | 100:0 | 55 (R) | 46 | 67 |
| | | −10, 16 | THF | 100:0 | 57 (R) | 100 | 65 |
| 15 | 2 | 0, 6 | THF | 100:0 | 73 (R) | 100 | 75 |
| 16 | 2 | −20, 16 | THF | 100:0 | 73 (R) | 85 | 65 |
| | | −10, 16 | THF | 100:0 | 70 (R) | 100 | 64 |
| 17 | 3 | −20, 16 | THF | 100:0 | 80 (R) | 83 | 71 |
| | | −10, 16 | THF | 100:0 | 80 (R) | 100 | 69 |
| | | −20, 16 | DME | 100:0 | 78 (R) | 93 | 62 |

### Examples 17 to 21

Rhodium-catalysed asymmetric hydrogenation of methyl (Z)-α-acetamidocinnamate

TABLE 4
Rhodium-catalysed asymmetric hydrogenation of methyl (Z)-α-acetamido-cinnamate

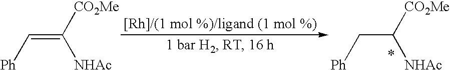

| Example | Ligand | Solvent | [Rh] | T [° C.], t [h] | % ee | Conversion | Yield |
|---|---|---|---|---|---|---|---|
| 18 | 1 | 1:10 | Rh(cod)₂BF₄ | 25, 16 | 78 (S) | 100 | 98 |
| | | (MeOH:toluene) | | | | | |
| 19 | 1 | 1:10 | Rh(cod)₂BF₄ | 25, 16 | 27 (S) | 100 | 98 |
| | | (MeOH:toluene) | | | | | |
| 20 | 1 | 1:1 | Rh(nbd)₂BF₄ | 25, 16 | 71 (S) | 100 | 97 |
| | | (MeOH:toluene) | | | | | |
| 21 | 1 | 1:10 | Rh(nbd)₂BF₄ | 25, 16 | 67 (S) | 100 | 97 |
| | | (CH₂Cl₂:MeOH) | | | | | |

### Example 22

Rhodium-catalysed asymmetric hydrogenation of acetophenone-phenylcarbonylhydrazone

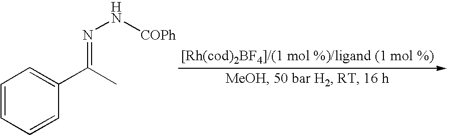

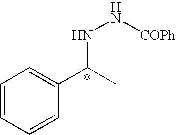

| Example | Ligand | % ee | Conversion | Yield |
|---|---|---|---|---|
| 22 | 2 | 19 (R) | 100 | 92 |

### Example 23

Ruthenium-catalysed asymmetric hydrogenation of ethyl 3-phenyl-3-oxopropanoate

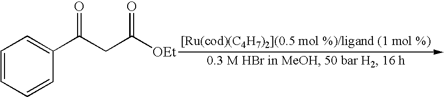

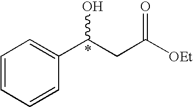

| Example | Ligand | % ee | Conversion | Yield |
|---|---|---|---|---|
| 23 | 2 | 7 (R) | 100 | 98 |

### Example 24

Palladium-catalysed asymmetric allylic substitution of 1,3-diphenylallyl acetate with methyl malonate

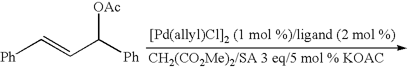

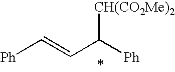

| Example | Ligand | % ee | Conversion | Yield |
|---|---|---|---|---|
| 24 | 2 | 28 (S) | 100 | 75 |

1. Compounds of the formula (I), 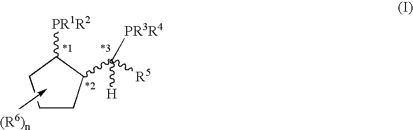
in which
*1, *2 and *3 each independently mark a stereogenic carbon atom which is in r- or s-configuration,
R¹, R², R³ and R⁴ may each independently be: alkyl, arylalkyl or aryl or a heterocyclic radical having a total of 4 to 16 carbon atoms, or R¹ and R² and/or R³ and R⁴ together may each be alkylene,
R⁵ may be: alkyl, arylalkyl or aryl and
R⁶ may be: alkyl, alkoxy, arylalkyl or aryl and
n maybe: 0, 1 or 2,
and the complexes thereof with boranes.

2. Compounds according to claim 1, characterized in that *1, *2 are selected such that the corresponding phosphine substituents, based on the level of the central five-membered ring, assume a cis-position and the compounds of the formula (I) are stereoisomerically enriched.

3. Compounds according to claim 1, characterized in that R¹ and R² or R³ and R⁴, each in pairs and identically, are: alkyl or aryl or a heterocyclic radical having a total of 4 to 9 carbon atoms, or, in each case together, are alkylene.

4. The following compounds according to claim 1:
(1R, 2R)-1-diphenylphosphino-2-(1S-diphenylphosphinoethyl)cyclopentane, (1R,2R)-1-diphenylphosphino-2-(1S-diphenylphosphino-2-methylpropyl)-cyclopentane and (1R, 2R)-1-diphenylphosphino-2-(S-diphenylphosphinocyclohexylmethyl)cyclopentane.

5. A process for preparing compounds of the formula (I) characterized in that
in a step A), compounds of the formula (II) 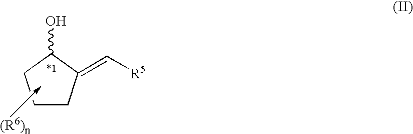
in which *1 and R⁵ each have the definitions and areas of preference specified in claim 1 and in which R⁵ may also be hydrogen are reacted with compounds of the formula (III)
Hal-PR³R⁴ (III)
to give compounds of the formula (IV) 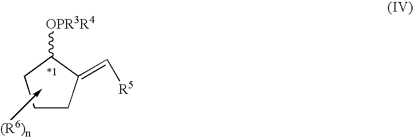
and
in a step B), the compounds of the formula (IV), optionally in an organic solvent, are converted by heating to at least 60° C. to compounds of the formula (V) 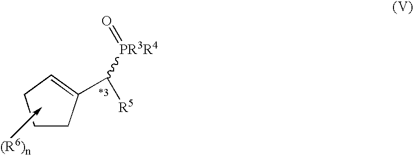
and, in a step C), the compounds of the formula (V) are converted by reacting with a borane and subsequently oxidizing to compounds of the formula (VI) 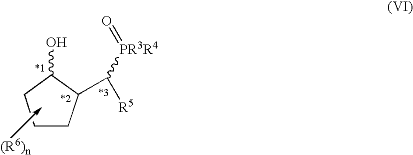
and, in a step D), the compounds of the formula (VI) are converted by reduction to compounds of the formula (VII) 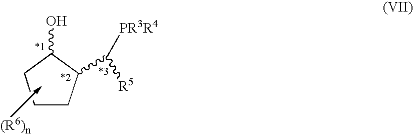
and, in a step E), the compounds of the formula (VII) are converted by reacting with compounds of the formula (VIII)
Hal-O₂SR⁷ (VIII)
to compounds of the formula (IX) 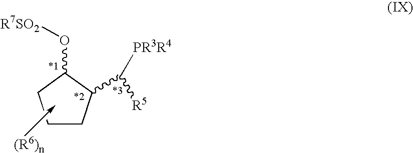
and, in a step F), the compounds of the formula (IX) are converted by reacting with compounds of the formula (X)
HPR¹R² (X)
into the compounds of the formula (I)
where, in the formulae (II), (IV), (V), (VI), (VII), (IX) and (X) *1, *2 and *3, R¹, R², R³, R⁴, R⁵ and R⁶ are each defined as has been specified under the formula (I) in claim 1 and
R⁷ in the formulae (VIII) and (IX) is alkyl, fluoroalkyl, arylalkyl or aryl and
Hal in the formulae (III) and (VIII) is in each case chlorine, bromine or iodine.

6. Process for preparing compounds of the formula (IV) according to claim 5, characterized in that it comprises step A) according to claim 5.

7. Process for preparing compounds of the formula (V) according to claim 5, characterized in that it comprises steps A) and B) according to claim 5.

8. Process for preparing compounds of the formula (VI) according to claim 5, characterized in that it comprises steps A), B) and C) according to claim 5.

9. Process for preparing compounds of the formula (VII) according to claim 5, characterized in that it comprises steps A), B), C) and D) according to claim 5.

10. Process for preparing compounds of the formula (IX) according to claim 5, characterized in that it comprises steps A), B), C), D) and E) according to claim 5.

11. Compounds of the formula (II) according to claim 5.

12. The following compounds of the formula (II) according to claim 5:
(1S)-2-ethylidenecyclopentanol, (1S)-2-(2-methylpropylidene)cyclopentanol and (1S)-2-cyclohexylmethylidenecyclopentanol.

13. Compounds of the formula (IV) according to claim 5.

14. The following compounds of the formula (IV) according to claim 5:
(1R)-diphenylphosphinoxy-2-ethylidenecyclopentane, (1R)-diphenylphosphinoxy-2-(2-methylpropylidene)cyclopentane and (1R)-diphenylphosphinoxy-2-cyclohexylmethylidenecyclopentane.

15. Compounds of the formula (V) according to claim 5.

16. The following compounds of the formula (V) according to claim 5:
(1S)-diphenylphosphinoylethylcyclopentene, ((1S)-diphenylphosphinoyl-2-methylpropyl)cyclopentene and ((1S)-diphenylphosphinoyl-1-methylcyclohexyl)cyclopentene.

17. Compounds of the formula (VI) according to claim 5.

18. The following compounds of the formula (VI) according to claim 5:
(1S, 2R)-1-hydroxy-2-(1S-diphenylphosphinoylethyl)cyclopentane, (1S, 2R)-1-hydroxy-2-(1S-diphenylphosphinoyl-2-methylpropyl)cyclopentane and (1S,2R)-1-hydroxy-2-(S-diphenylphosphinoylcyclohexylmethyl)cyclopentane.

19. Compounds of the formula (VI) according to claim 5 and the complexes thereof with boranes.

20. The following compounds of the formula (VII) according to claim 5:
(1S,2R)-1-hydroxy-2-(1S-diphenylphosphinoethyl)cyclopentane,
(1S, 2R)-1-hydroxy-2-(1S-diphenylphosphino-2-methylpropyl)cyclopentane and
(1S,2R)-1-hydroxy-2-(S-diphenylphosphinocyclohexylmethyl)cyclopentane and the complexes thereof with boranes.

21. Compounds of the formula (IX) according to claim 5.

22. The following compounds of the formula (IX) according to claim 5:
(1S,2R)-1-methanesulphonyloxy-2-(1S-diphenylphosphinoethyl)cyclopentane, (1S, 2R)-1-methanesulphonyloxy-2-(1S-diphenylphosphino-2-methylpropyl)-cyclopentane and (1S,2R)-1-methanesulphonyloxy-2-(S-diphenylphosphino-cyclohexylmethyl)cyclopentane.

23. Transition metal complexes containing compounds according to claim 1.

24. Catalysts comprising transition metal complexes according to claim 23.

25. Use of catalysts according to claim 24 for preparing stereoisomerically enriched compounds.

26. Process for preparing stereoisomerically enriched compounds, characterized in that the preparation is effected in the presence of catalysts according to claim 24.

27. Process according to claim 26, characterized in that the catalysts are used for asymmetric 1,4-additions, asymmetric hydroformylations, asymmetric allylic substitutions, asymmetric hydrocyanations, asymmetric Heck reactions, asymmetric hydroborations and asymmetric hydrogenations.
